(19) United States
(12) Patent Application Publication
(10) Pub. No.: US 2014/0089599 A1
(43) Pub. Date: Mar. 27, 2014

(54) PROCESSOR AND CONTROL METHOD OF PROCESSOR

(71) Applicant: FUJITSU LIMITED, Kawasaki-shi (JP)

(72) Inventor: Hideki OKAWARA, Kawasaki (JP)

(73) Assignee: FUJITSU LIMITED, Kawasaki-shi (JP)

(21) Appl. No.: 13/950,333

(22) Filed: Jul. 25, 2013

(30) Foreign Application Priority Data
Sep. 21, 2012 (JP) 2012-208692

(51) Int. Cl. G06F 12/08

(52) U.S. Cl. CPC G06F 12/0855
USPC 711/140

(57) ABSTRACT

A processor includes a cache write queue configured to store write requests, based on store instructions directed to a cache memory issued by an instruction issuing unit, into entries provided with stream_wait flag, and to output a write request including no stream_wait flag set thereon, from among the stored write requests, to a pipeline operating unit which performs pipeline operation with respect to the cache memory, the cache write queue being further configured to determine, when a stream flag attached to the store instruction is set, that there will be succeeding store instruction directed to a data area same as that accessed by the store instruction, to set the stream_wait flag so as to store the write request into the entry, to merge the write requests based on the store instructions, directed to the same data area, into a single write request, and then to hold the merged write request.

### CROSS-REFERENCE TO RELATED APPLICATION

This application is based upon and claims the benefit of priority of the prior Japanese Patent Application No. 2012-208692, filed on Sep. 21, 2012, the entire contents of which are incorporated herein by reference.

### FIELD

The embodiment relates to a processor, and a control method of a processor.

### BACKGROUND

Hardware prefetch has been known as a technique for improving performance of stream-like access, which means a consecutive access to data areas having consecutive addresses. The hardware prefetch is a technique of detecting, on the hardware basis, the consecutive access so as to be repeated for every cache line (for every 128 bytes, for example), and of preliminarily storing data supposed to be necessary later into a cache memory.

There has been proposed a technique of providing a write buffer in a microprocessor, directing the write buffer to store data to be written into a memory, and asynchronously writing the contents of the write buffer into a cache memory or main memory, when a memory bus or the cache memory is available (see Patent Document 1, for example). There has also been proposed a technique of providing a store buffer and a write buffer for holding store data, and merging the store data when the store data is transferred from the store buffer to the write buffer (see Patent Document 2, for example).
[Patent Document 1] Japanese Laid-open Patent Publication No. 07-152566
[Patent Document 2] Japanese Laid-open Patent Publication No. 2006-48163

The hardware prefetch technique can hide performance overhead ascribable to latency of access to a main memory or the like, in a cache-miss case which means occurrence of cache-miss in the cache memory. The hardware prefetch technique has, however, no effect of improving performance of the stream-like access in the cache-hit case which means that the cache memory is hit.

In addition, it is difficult for the hardware to detect completion of stream-like access. Accordingly, when the hardware prefetch technique is used, it is general to also prefetch unnecessary data at the end of the stream-like access, and also any other techniques similar to the hardware prefetch have been suffering from difficulty in exactly detecting the stream-like access repeated for every smaller number, or a several number of instructions. Moreover, since the number of times of write operation into the cache memory has not been reduced, there has been no idea of reducing the power consumption.

### SUMMARY

In one aspect, a processor includes: an instruction issuing unit that decodes a program product, and issues an instruction corresponded to a result of decoding; a buffer unit that includes a plurality of entries each provided with a cache write inhibition flag, and stores write requests based on the store instruction directed to a cache memory into the entries, and outputs a write request including no cache write inhibition flag set thereon, from among the stored write requests; and a pipeline operating unit that performs pipeline operation regarding data writing to the cache memory, in response to the write request output from the buffer unit. The buffer unit determines, when a first flag attached to the fed store instruction is set, that there will be succeeding store instruction directed to a data area same as that accessed by the store instruction, sets the cache write inhibition flag and stores the write request based on the store instruction into the entry. The buffer unit also merges the write requests based on the store instruction, directed to the same data area, into a single write request, and then holds the merged write request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an exemplary configuration of a processor in an embodiment;

FIG. 2 is a drawing illustrating an exemplary configuration of a cache write queue in this embodiment;

FIG. 3 is a flow chart illustrating store operation of store instructions into the cache write queue in this embodiment;

FIG. 4 is a drawing illustrating an exemplary pipeline operation for cache access in this embodiment; and

FIG. 5 is a drawing illustrating an exemplary pipeline operation for cache access in the prior art.

### DESCRIPTION OF EMBODIMENTS

Embodiments will be detailed below, referring to the attached drawings.

When a load instruction or store instruction is executed, a processor has implemented read/write of cache memory so as to be repeated for every instruction. Accordingly, in the stream-like access directed to consecutive data areas, the processor has implemented cache pipeline operation or read/write of cache memory, so as to be repeated for every instruction.

A processor of this embodiment described below executes a plurality of write operations directed to the cache memory, in response to a plurality of store instructions in the stream-like access, after being merged into a single write operation. By merging a plurality of write operations to the cache memory into a single write operation, and by executing the merged write operation, the number of times of write operation to the cache memory may be reduced, thereby the performance may be improved, and the power consumption may be reduced.

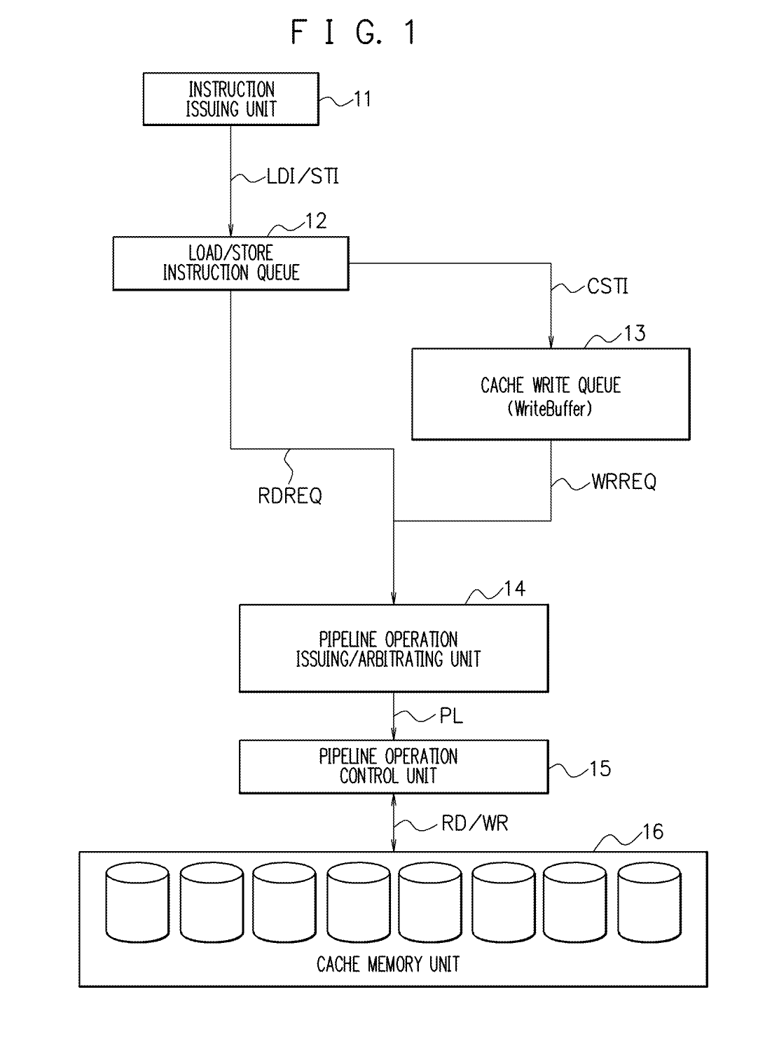

FIG. 1 is a block diagram illustrating an exemplary configuration of the processor in this embodiment. The processor in this embodiment has an instruction issuing unit 11, a load/store instruction queue 12, a cache write queue (WriteBuffer) 13, a pipeline operation issuing/arbitrating unit 14, a pipeline operation control unit 15, and a cache memory unit 16.

The instruction issuing unit 11 decodes a program product read out from a main memory or the like, and issues an instruction. If the instruction issued by the instruction issuing unit 11 is a load instruction LDI which directs reading of data from a memory or the like, or a store instruction STI which directs writing of data into a memory or the like, the instruction LDI/STI enters the load/store instruction queue 12. While instructions other than the load instruction LDI and the store instruction STI are not illustrated in FIG. 1, the instruction issuing unit 11 also issues other processing instructions such as calculation instruction directed to the individual functional unit such as computing unit.

Upon receiving the load instruction LDI from the instruction issuing unit 11, the load/store instruction queue 12 outputs a cache read request RDREQ corresponded to the load instruction LDI to the pipeline operation issuing/arbitrating unit 14. Once the store instruction STI is received from the instruction issuing unit 11 and determined to be executed, that is, when committed, the load/store instruction queue 12 also outputs the thus-committed store instruction CSTI to the cache write queue 13.

The cache write queue 13 allows the committed store instruction CSTI to stay as a cache write request waiting for being written into the cache memory, together with write data (store data) fed by the arithmetic unit or the like. When the cache write request having been kept staying becomes writable into the cache memory, the cache write queue 13 outputs cache write request WRREQ to the pipeline operation issuing/arbitrating unit 14. For an exemplary case where the cache write queue 13 does not activate the cache write operation due to cache-miss immediately, it allows the request to stay therein until the request becomes writable. Upon reaching the writable state, the cache write queue 13 then outputs the cache write request WRREQ.

In addition, in this embodiment, a stream_wait flag is provided to every entry in the cache write queue 13, according to which the cache write queue 13 controls output of the stored cache write request. If the stream_wait flag is set (with a value of “1”), the cache write queue 13 inhibits the output of the cache write request and keeps it staying, even if the request is writable into the cache memory. On the other hand, if a destination of access of the succeedingly entered store instruction is contained in the data area accessible by the thus-held preceding cache write request based on the store instruction, the cache write queue 13 merges the preceding cache write request and the succeeding store instruction into a single cache write request, and holds the merged write request.

The pipeline operation issuing/arbitrating unit 14 receives cache read request RDREQ from the load/store instruction queue 12, and receives cache write request WRREQ from the cache write queue 13. The pipeline operation issuing/arbitrating unit 14 issues pipeline operation PL regarding access to a primary cache memory, based on the cache read request RDREQ and the cache write request WRREQ. Upon issuance of the pipeline operation, the pipeline operation issuing/arbitrating unit 14 also arbitrates internal processing, typically corresponding to cache-miss in the cache memory unit 16.

The pipeline operation control unit 15 executes cache read operation RD for reading data from the cache memory unit 16, and cache write operation WR for writing data thereinto, corresponding to the pipeline operation PL issued by the pipeline operation issuing/arbitrating unit 14. The cache memory unit 16 has a plurality of RAMs (Random Access Memories).

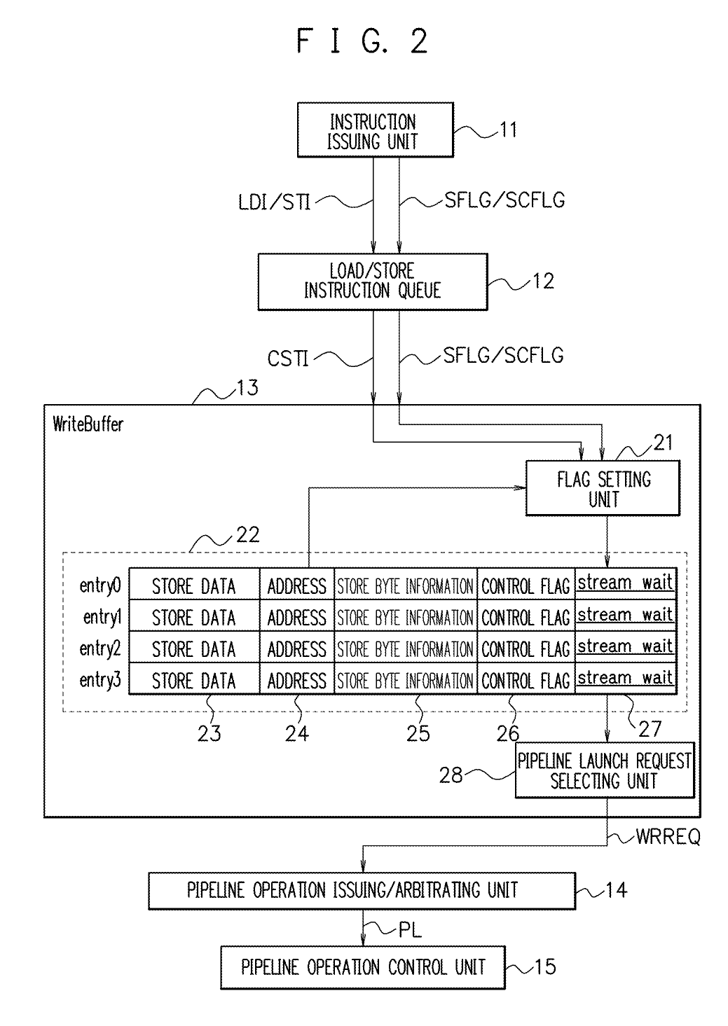

FIG. 2 is a block diagram illustrating an exemplary internal configuration of the cache write queue in this embodiment. In FIG. 2, all constituents same as those illustrated in FIG. 1 are given the same reference numerals, so as to avoid repetitive explanations. The cache write queue 13 has a flag setting unit 21, an entry unit 22, and a pipeline launch request selecting unit 28.

The flag setting unit 21 refers to stream flag SFLG and stream_complete flag SCFLG added to the committed store instruction CSTI, and sets the stream_wait flag corresponding to values of the flags SFLG, SCFLG. The committed store instruction CSTI output from the load/store instruction queue 12 contains store data, address to be accessed, and data length (data width).

In this embodiment, the store instruction is added with the stream flag SFLG and the stream_complete flag SCFLG. The stream flag SFLG and the stream_complete flag SCFLG are used for informing the hardware, from the software (program product), with a state regarding the stream-like access for every store instruction, in order to determine whether there will be any succeeding store instruction directed to a data area same as that accessed by the preceding store instruction, or not.

The stream flag SFLG regarding the stream-like access has a value of “1” for stream-like access, and has a value of “0” for non-stream-like access. The stream_complete flag SCFLG regarding completion of the stream-like access has a value of “1” for the last store instruction STI in the stream-like access, and has a value of “0” for the other store instructions STI (including the non-stream-like access).

In other words, in the period over which the stream-like access continues, the store instruction is issued with the value of the stream flag SFLG set to “1”, and with the value of the stream_complete flag SCFLG set to “0” on the program basis. At the end of the stream-like access, the last store instruction of the stream-like access is issued with the value of the stream flag SFLG set to “1”, and with the value of the stream_complete flag SCFLG set to “1” on the program basis. The store instruction in the non-stream-like access is issued with both of the stream flag SFLG and the stream_complete flag SCFLG set to “0”, on the program basis.

The flag setting unit 21 determines whether there will be any succeeding store instruction directed to a data area same as that accessed by the store instruction CSTI, based on the stream flag SFLG and the stream_complete flag SCFLG added to the committed store instruction CSTI, or not. The flag setting unit 21 then sets the stream_wait flag as described below, corresponding to a result of determination, an address to be accessed indicated by the store instruction CSTI, and the data length. The setting of the stream_wait flag by the flag setting unit 21 described below is implemented typically by using a logic circuit using the stream flag SFLG, the stream_complete flag SCFLG, and a lower bit value of the address to be accessed corresponded to data length.

(A) A case with the stream flag SFLG added to the committed store instruction CSTI having a value of “1”, and with the stream_complete flag SCFLG having a value of “0”.

(A-1) When a given store instruction is not a store instruction directed to the last data in the length of consecutive data writable into the cache memory, the flag setting unit 21 determines that there will be any succeeding store instruction directed to the same data area, based on the address to be accessed and the data length indicated by the store instruction CSTI. When the cache write request based on the store instruction CSTI is stored into an entry of the cache write queue 13, the flag setting unit 21 sets the value of stream_wait flag of this entry to “1”, in order to inhibit any output of the cache write request from this entry.

For example, if the length of consecutive data writable at the same time into the cache memory is 16 bytes, and if the data length indicated by the store instruction CSTI is 1 byte, a given store instruction is not the last store instruction in the 16-byte width, if the lower 4 bits of the address to be accessed represent a value other than “0xF”. Similarly, if the data length indicated by the store instruction CSTI is 4 bytes, a given store instruction is not the last store instruction in the 16-byte width, if the lower 4 bits of the address to be accessed represent a value other than “0xC”. The flag setting unit 21 therefore sets the value of the stream_wait flag to “1”, so as to inhibit output of the cache write request, and keeps it staying. The length of consecutive data writable at the same time into the cache memory is determined by hardware such as entry configuration of the WriteBuffer unit, and RAM configuration of the cache memory unit.

(A-2) When a given store instruction is a store instruction directed to the last data in the length of consecutive data writable into the cache memory, the flag setting unit 21 determines that there will be no more succeeding store instruction directed to the same data area, based on the address to be accessed and the data length indicated by the store instruction CSTI. When the cache write request based on the store instruction CSTI is stored into an entry of the cache write queue 13, the flag setting unit 21 sets the value of the stream_wait flag of this entry to “0”. While this state assigns value “0” for the stream_complete flag SCFLG, the value of the stream_wait flag is set to “0”, because the performance will no longer be improved from the viewpoint of hardware control, even if the cache write request is allowed to stay any longer.

For example, if the length of consecutive data writable at the same time into the cache memory is 16 bytes, and if the data length indicated by the store instruction CSTI is 1 byte, a given store instruction is the last store instruction in the 16-byte width, if the lower 4 bits of the address to be accessed represent a value of “0xF”. Similarly, if the data length indicated by the store instruction CSTI is 4 bytes, a given store instruction is the last store instruction in the 16-byte width, if the lower 4 bits of the address to be accessed represent a value of “0xC”. The flag setting unit 21 therefore sets the value of the stream_wait flag to “0”, so as to enable output of the cache write request.

(B) A case with the stream flag SFLG added to the committed store instruction CSTI having a value of “1”, and with the stream_complete flag SCFLG having a value of “1”.

The flag setting unit 21 determines that the stream-like access completed, and there will be no more succeeding store instruction directed to the same data area. When the cache write request based on the store instruction CSTI is stored into an entry of the cache write queue 13, the flag setting unit 21 sets the value of the stream_wait flag of this entry to “0”, so as to enable output of the cache write request from this entry.

(C) A case with the stream flag SFLG added to the committed store instruction CSTI having a value of “0”.

The flag setting unit 21 determines that there is no stream-like access, and that there is no succeeding store instruction directed to the same data area. When the cache write request based on the store instruction CSTI is stored into an entry of the cache write queue 13, the flag setting unit 21 sets the value of the stream_wait flag of this entry to “0”, so as to enable output of the cache write request from this entry.

The entry unit 22 has a plurality of entries into which the cache write requests based on the store instruction CSTI are stored. While FIG. 2 illustrates an exemplary case where the entry unit 22 has four entries from entry0 to entry3, the number of entries is arbitrary. Each entry has store data 23 which is data to be written, an address 24 which indicates a write destination, store byte information 25 which indicates a byte position of data to be written, a control flag 26 used for various control, and a stream_wait flag 27. Upon receiving the store instruction CSTI with a value of the stream flag SFLG of “1”, the cache write queue 13 compares an address to be accessed indicated by the store instruction CSTI and addresses 24 of the individual entries, and merges the store instructions CSTI if any entries directed to the same data area are found.

The pipeline launch request selecting unit 28 refers to the stream_wait flags 27 of the individual entries in the entry unit 22, and outputs the cache write request WRREQ based on the entry corresponding to the value, to the pipeline operation issuing/arbitrating unit 14. If there is an entry having a value of the stream_wait flag 27 of “0”, which indicates a state writable into the cache memory, the pipeline launch request selecting unit 28 outputs the cache write request WRREQ based on the entry to the pipeline operation issuing/arbitrating unit 14.

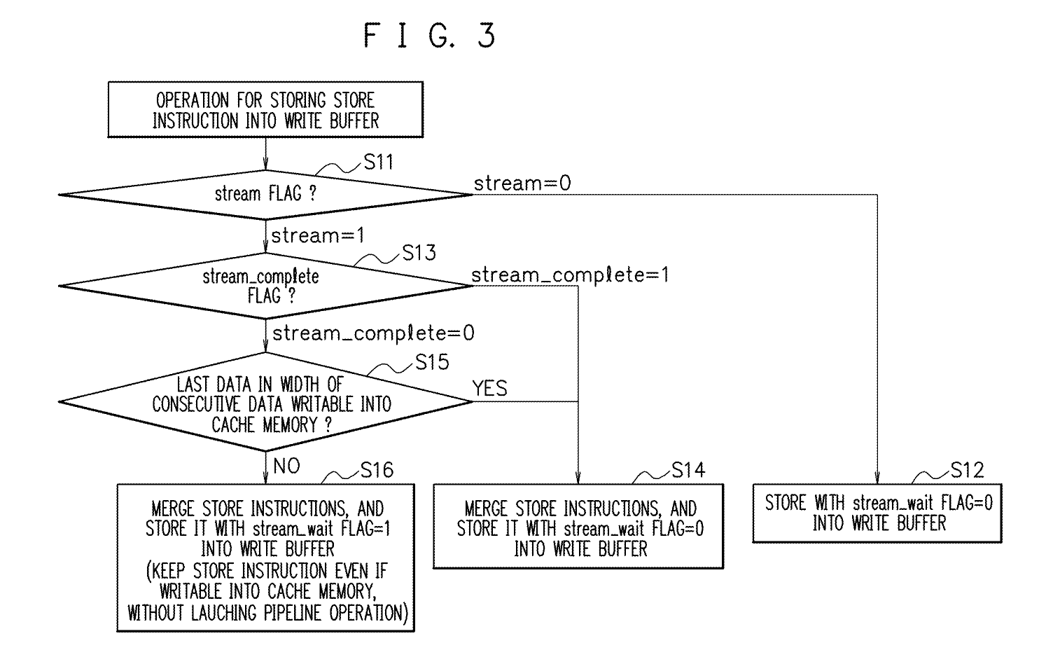

FIG. 3 is a flow chart illustrating a store operation for storing the store instruction into the cache write queue 13 in this embodiment.

Upon input of the committed store instruction CSTI added with the stream flag SFLG and the stream_complete flag SCFLG into the cache write queue 13, the flag setting unit 21 confirms the value of the stream flag SFLG (S11). If the stream flag SFLG has a value of “0”, the flag setting unit 21 determines that there is a non-stream-like access, sets the value of the stream_wait flag to “0”, and thereby the cache write request based on the store instruction CSTI is stored into the entry (S12).

On the other hand, if the stream flag SFLG has a value of “1”, the flag setting unit then confirms the value of the stream_complete flag SCFLG (S13). If the stream_complete flag SCFLG has a value of “1”, the flag setting unit 21 determines that the stream-like access has completed, sets the value of the stream_wait flag to “0”, and thereby the cache write request based on the preceding store instruction and the cache write request based on the store instruction CSTI are merged and stored into the entry (S14).

If the stream_complete flag SCFLG was found to have a value of “0” by the determination in step S13, the flag setting unit then confirms whether a given data is the last data in the length of consecutive data writable into the cache memory, based on the address to be accessed and the data length indicated by the store instruction CSTI (S15). If the store instruction CSTI is directed to the last data in the length of consecutive data writable into the cache memory, the value of the stream_wait flag is set to “0” by the flag setting unit 21, and thereby the cache write request based on the preceding store instruction and the cache write request based on the store instruction CSTI are merged and stored into the entry (S14). On the other hand, if the store instruction CSTI is not directed to the last data in the length of consecutive data writable into the cache memory, the value of the stream_wait flag is set to “1” by the flag setting unit 21, and thereby the cache write request based on the preceding store instruction and the cache write request based on the store instruction CSTI are merged and stored into the entry (S16).

According to this embodiment, when it is determined that there will be succeeding store instruction directed to a data area same as that accessed by the store instruction CSTI, the stream_wait flag is set (the value is set to “1”), and the cache write request based on the store instruction CSTI is stored in the entry of the cache write queue 13. By setting the stream_wait flag, the cache write queue 13 inhibits output of the cache write request from the entry, even if the request is writable into the cache memory, and keeps it staying in the cache write queue 13. When the succeeding store instruction directed to the same data area is committed, the preceding cache write request being stored and the succeeding store instruction are merged into a single cache write request, and is stored. In this way, the number of write request output in response to the store instructions in the stream-like access may be reduced, and thereby the number of pipelines used for the cache memory access, and the number of times of writing to the cache memory may be reduced. Accordingly, the performance of the stream-like access in the processor may be improved, and the power consumption may be reduced.

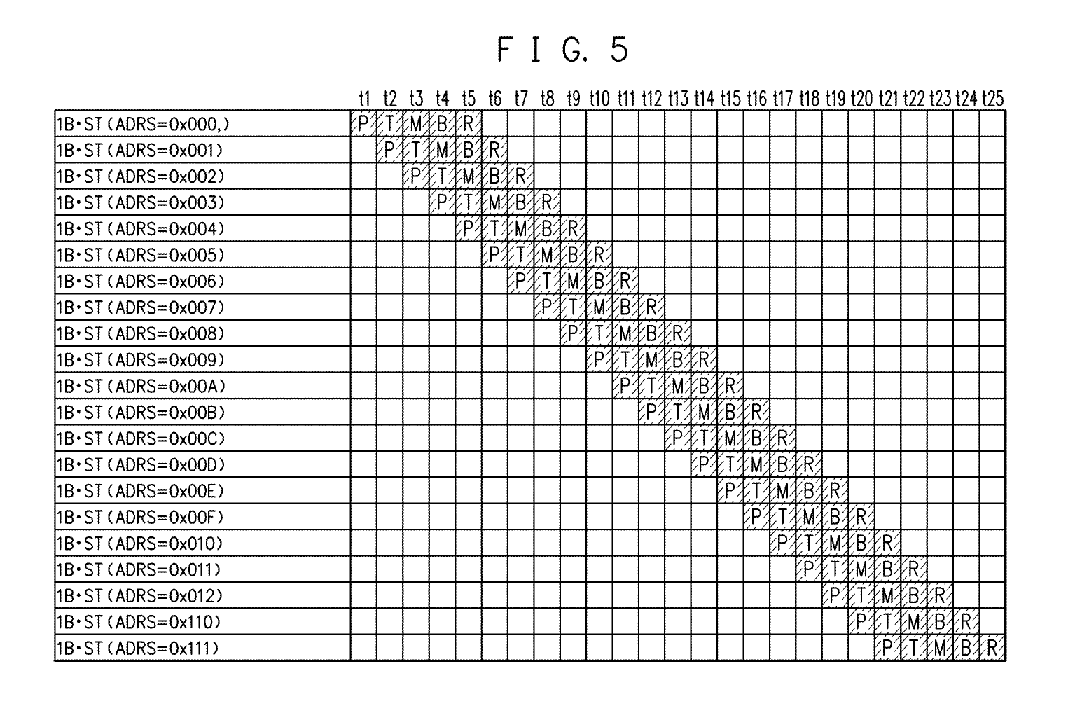

Assuming now, for example, that the length of consecutive data writable into the cache memory in one cycle is 16 bytes, and stream-like access based on 1-byte store instructions directed to addresses 0x000 to 0x012 in hexadecimal notation, and 1-byte load instructions directed to addresses 0x110 and 0x111 are executed. In this case, upon output of the cache write request for every store instruction, the pipeline operation is launched in each cycle as illustrated in FIG. 5.

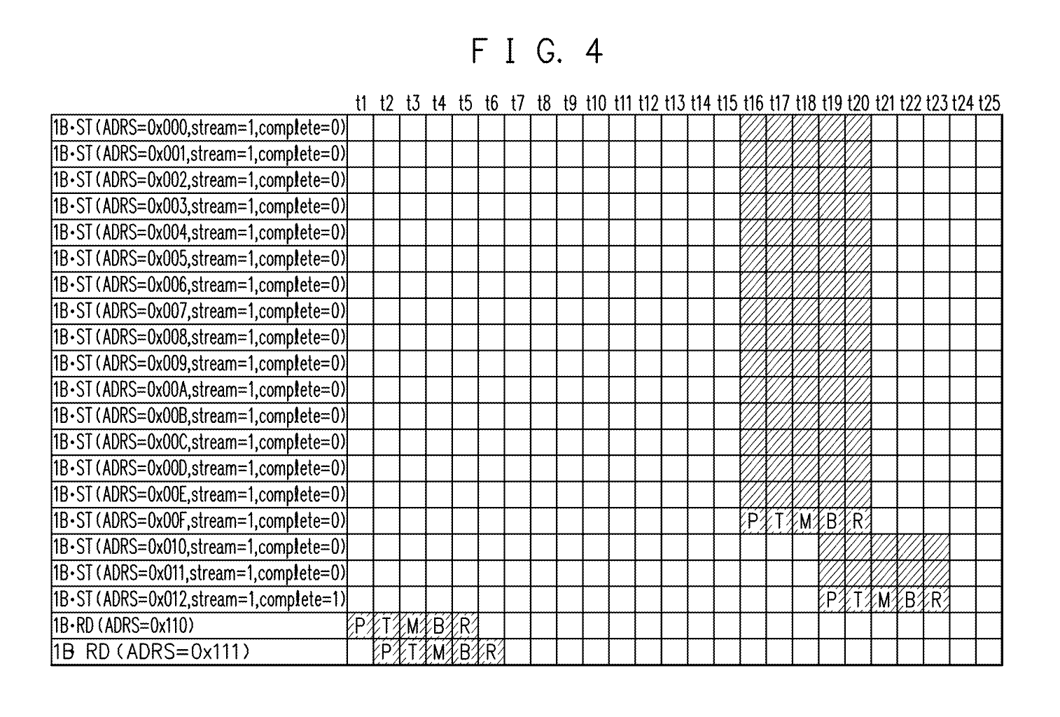

On the other hand, according to this embodiment, as illustrated in FIG. 4, the pipeline operation is launched only after merging sixteen 1-byte store instructions directed to addresses 0x000 to 0x00F, and three 1-byte store instructions directed to addresses 0x010 to 0x012, respectively into a single cache write request. Accordingly, efficiency of use of the pipeline regarding the cache memory access may be improved, and the number of times of writing into the cache memory may be reduced.

Note that FIG. 4 and FIG. 5 show exemplary cases where the pipeline regarding the cache memory access have a five-stage configuration which includes “P (Priority)”, “T (Tag)”, “M (Match)”, “B (BufferRead)”, and “R (Result)”. Priority of the instructions executed by a priority logic circuit is determined in the P stage, the cache memory is accessed and a tag is read out in the T stage makes, and the tag is matched in the M stage. Data is selected and stored in the buffer in the B stage, and the data is transferred in the R stage.

When, for example, the length of consecutive data writable to the cache memory in one cycle is 32 bytes, 32 store instructions may be merged into one cache write request for the stream-like access by 1-byte store instructions, and 8 store instructions may be merged for the stream-like access by 4-byte store instructions.

In this embodiment described above, the flag setting unit 21 sets the value of the stream_wait flag to “0”, based on the value of the stream_complete flag SCFLG, and the address to be accessed and the data length indicated by the store instruction CSTI. Alternatively, the flag setting unit 21 may unconditionally set the value of the stream_wait flag to “0”, when a certain number of instructions having the value of the stream_wait flag remained in “1” are received, or when the cache write queue 13 no longer has available entry. In this case, even if the value of the stream_complete flag SCFLG is erroneously set to “0” in the last store instruction of the stream-like access due to a malfunctioning program, the cache write request may be prevented from being kept staying in the cache write queue 13.

Alternatively, the flag setting unit of the cache write queue 13 may also use a technique described below, as a method of determining whether there will be any succeeding store instruction directed to the same data area. On the program basis, the store instruction is added only with the stream flag SFLG which indicates the stream-like access. The hardware which functions as an instruction issuing unit 11 determines that a duration over which an executed program cycles through the innermost loop (for example, a duration over which a branch prediction TAKEN persists) is a duration over which the same process continues, and the instruction issuing unit 11 then creates information of the stream_complete flag SCFLG with value “0”, and issues the store instruction. On the other hand, if the hardware determines that the innermost loop completed (for an exemplary case with branch prediction NOT-TAKEN), the instruction issuing unit 11 creates information of the stream_complete flag SCFLG with value “1”, and issues the store instruction.

Alternatively, for the case of so-called, out-of-order processor by which the instructions may be executed in an order differently from that described in a program, it suffices that the store instruction such as changing the value of the stream_wait flag from “1” to “0” is executed after all other store instructions directed to the same data area are executed. In this way, it is now possible to avoid an event such that the value of the stream_wait flag is changed from “1” to “0” and thereby the cache write request is unfortunately output, before all store instructions directed to the same data area are executed.

According to the embodiment, since the write requests based on the store instruction directed to the same data area are merged into a single write request, so that the number of times of writing to the cache memory may be reduced, and thereby the performance may be improved and the power consumption may be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
an instruction issuing unit that decodes a program product, and issues an instruction corresponded to a result of decoding;
a buffer unit that includes a plurality of entries each provided with a cache write inhibition flag, and, if the instruction issued by the instruction issuing unit is a store instruction, then stores write requests based on the store instruction directed to a cache memory into the entries, and outputs a write request including no cache write inhibition flag set thereon, from among the stored write requests; and
a pipeline operating unit that performs pipeline operation regarding data writing to the cache memory, in response to the write request output from the buffer unit,
wherein the buffer unit determines, when a first flag attached to the fed store instruction is set, that there will be succeeding store instruction directed to a data area same as that accessed by the store instruction, and sets the cache write inhibition flag and stores the write request based on the store instruction into the entry, merges the write requests based on the store instructions, directed to the same data area, into a single write request, and then holds the merged write request.

2. The processor according to claim 1,
wherein the buffer unit determines, when a second flag, different from the first flag, attached to the store instruction is set, that the store instruction is the last store instruction, from among the store instructions directed to the same data area, and unsets the cache write inhibition flag when the write request based on the store instruction is stored into the entry.

3. The processor according to claim 2,
wherein the buffer unit unsets the cache write inhibition flag when the write request based on the store instruction is stored into the entry, if the store instruction is determined to be a store instruction regarding the last data in the consecutive data length writable by a single pipeline operation, based on an address to be accessed and data length indicated by the fed store instruction.

4. The processor according to claim 1,
wherein the first flag is a flag that indicates stream-like access performing a consecutive access to consecutive data areas.

5. The processor according to claim 2,
wherein the first flag is a flag that indicates stream-like access performing a consecutive access to consecutive data areas, and
the second flag is a flag that indicates completion of the stream-like access.

6. A control method of a processor comprising:
by an instruction issuing unit of the processor, decoding a program product and issuing an instruction corresponded to a result of decoding;
if the instruction issued by the instruction issuing unit is a store instruction, by a buffer unit of the processor, having a plurality of entries each provided with a cache write inhibition flag, storing write requests based on the store instructions directed to a cache memory into the entry;
by the buffer unit, outputting a write request including no cache write inhibition flag set thereon, from among the write requests stored in the entries; and
by a pipeline operating unit of the processor, performing pipeline operation regarding data writing to the cache memory, in response to the write request output from the buffer unit,
in the process of storing the write requests into the entries, and when a first flag attached to the store instruction is set, the buffer unit determining that there will be succeeding store instruction directed to a data area same as that accessed by the store instruction, setting the cache write inhibition flag and storing the write requests based on the store instructions into the entry, and merging the write requests based on the store instructions, directed to the same data area, into a single write request, and then holding the merged write request.

7. The control method of the processor according to claim 6,
wherein the buffer unit initializes the cache write inhibition flag, when the write request is stored with the cache write inhibition flag set thereon, and a certain period elapsed while keeping the cache write inhibition flag set thereon, or, when the buffer unit no longer has available entry.
